(19) United States
(12) Patent Application Publication
(10) Pub. No.: US 2017/0279616 A1
(43) Pub. Date: Sep. 28, 2017

(54) DYNAMIC USER BEHAVIOR RHYTHM PROFILING FOR PRIVACY PRESERVING PERSONALIZED SERVICE

(71) Applicant: INTERDIGITAL TECHNOLOGY CORPORATION, Wilmington, DE (US)

(72) Inventors: Shoshana Loeb, Philadelphia, PA (US); Kuo-Chu Lee, Princeton Junction, NJ (US); Zijun Yao, North Arlington, NJ (US)

(73) Assignee: INTERDIGITAL TECHNOLOGY CORPORATION, Wilmington, DE (US)

(21) Appl. No.: 15/512,413

(22) PCT Filed: Sep. 18, 2015
(86) PCT No.: PCT/US2015/050968

§ 371 Date: Mar. 17, 2017

Related U.S. Application Data
(60) Provisional application No. 62/052,760, filed on Sep. 19, 2014.

(51) Int. Cl. H04L 9/32; G06F 21/60; H04W 12/02; H04L 29/06; H04L 29/08; G06F 21/62; H04L 9/06

(52) U.S. Cl. CPC H04L 9/3247; G06F 21/6245; G06F 21/602; H04L 9/0643; H04L 63/0421; H04L 67/22; H04W 12/02; H04L 67/02; H04L 2209/80

(57) ABSTRACT

Methods and apparatuses are described herein to identify the anonymous events which may belong to the same customer by providing inter-event virtual linkage sequence to link anonymous behavior data from multiple independent sessions. The behavior data may be encrypted without tracking or storing all other types of data such as contact information. An anonymous user may be identified and categorized based on rhythms of predictive behavior pattern sequences by extracting signatures the rhythms to provide fast content based search to identify one or more similar behavior event patterns from a set of data. The signatures may include multiple time series vectors, which may be matched to unique patterns. Personalized services may be offered to anonymous offer pools and may be based on event patterns categories defined and detected by customized rules. The application or game may use the data collection inter-session virtual link to pull the service offer.

### CROSS REFERENCE TO RELATED APPLICATION

This application is the U.S. National Stage, under 35 U.S.C. §371, of International Application No. PCT/US2015/050968 filed Sep. 18, 2015, which claims the benefit of U.S. Provisional Application No. 62/052,760 filed Sep. 19, 2014, the content of which is hereby incorporated by reference herein.

### BACKGROUND

User profiling may be used for marketing and customer relationship management. A typical user profile may include personal, demographic, and/or application specific behavior data. Recent advances in social networking, location services, mobile applications (“apps”) and games have enabled collection and analysis of user interactions within mobile apps and games. Such in-app and in-game interaction data may be used to support in-app advertising, to improve game design, and/or to provide personalized service, which may facilitate improved user experience and customer retention. By collecting more information about a specific user, more personalized services may be tailored for that user. However, such personalized services may raise privacy concerns, especially if they reveal knowledge obtained by monitoring activities of the users beyond the intended scope of the mobile apps and games.

While many customer profiling systems may adopt policies, operation procedures, and new technologies to protect customer information, both companies and customers may still have concerns about the consequences of data leaks and the misuse of personal information. Privacy protection has been a complex subject, which is under active research.

### SUMMARY

Methods and apparatuses are described herein to identify the anonymous events which may belong to the same customer by providing inter-event virtual linkage sequence to link anonymous behavior data from multiple independent sessions. The behavior data may be encrypted without tracking or storing all other types of data such as contact information. An anonymous user may be identified and categorized based on rhythms of predictive behavior pattern sequences by extracting signatures the rhythms to provide fast content based search to identify one or more similar behavior event patterns from a set of data. The signatures may include multiple time series vectors, which may be matched to unique patterns. Personalized services may be offered to anonymous offer pools and may be based on event patterns categories defined and detected by customized rules. The application or game may use the data collection inter-session virtual link to pull the service offer.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of an example communications system in which one or more disclosed embodiments may be implemented;

FIG. 2 is a system diagram which illustrates an example system for implementing a privacy-preserving user profiling service;

FIG. 3 is a flow diagram which illustrates aspects of an example method for extracting a time-varying signature;

FIGS. 4A and 4B are a vector diagram and a flow diagram showing a method for predicting and matching rhythms of event patterns;

FIG. 5 is a graph which illustrates example “rhythms” of the play event patterns of three players;

FIG. 6 is a flow chart which illustrates aspects of an example method 600 for tracking anonymous users by generating predicted skill vectors (PSVs);

FIGS. 7A and 7B are calendars which illustrate example signatures derived from game session play time, duration, and win rate, and skill level assessment vectors of behavior data sets over a month;

FIG. 8 is a block diagram illustrating an example system for supporting an analytics function while preserving users' privacy; and

FIG. 9 is a block diagram of an example system for storing user metrics and user behavior rhythms in a data cube.

### DETAILED DESCRIPTION

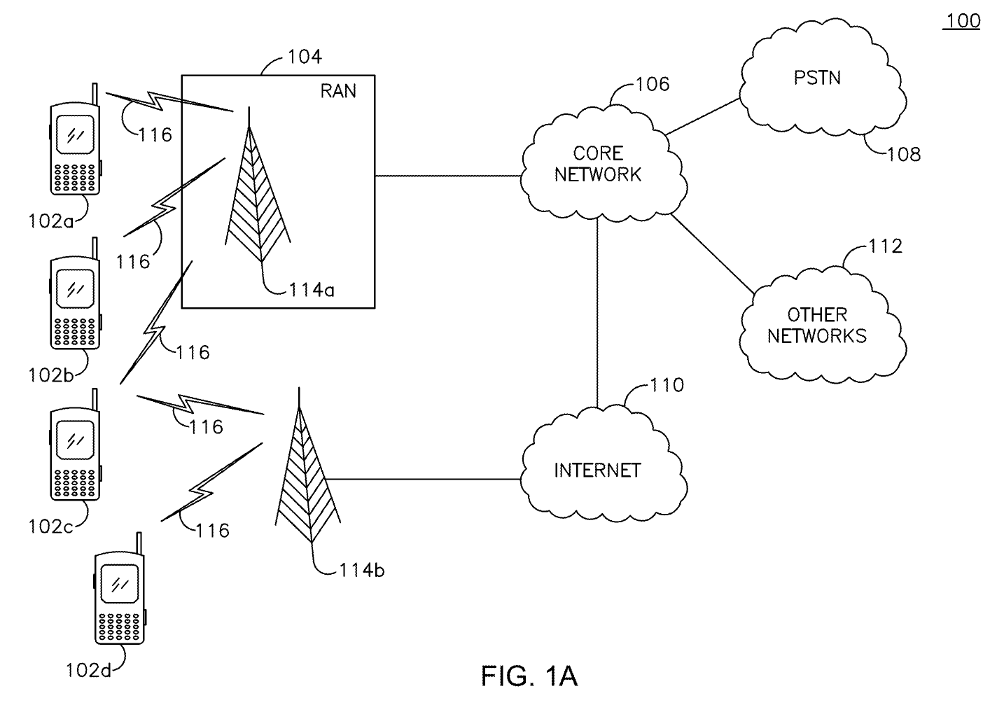

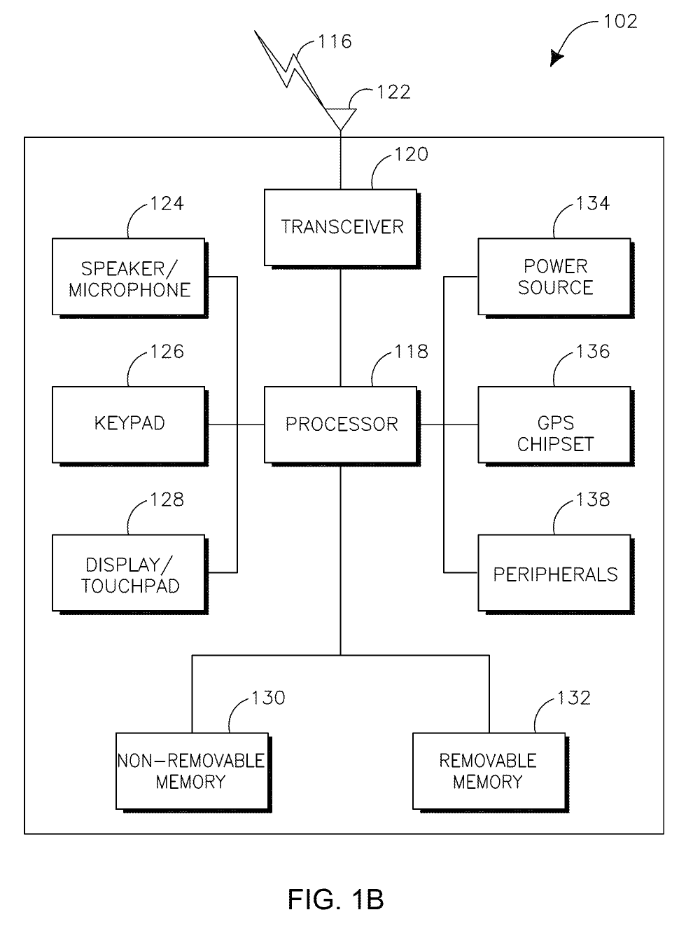

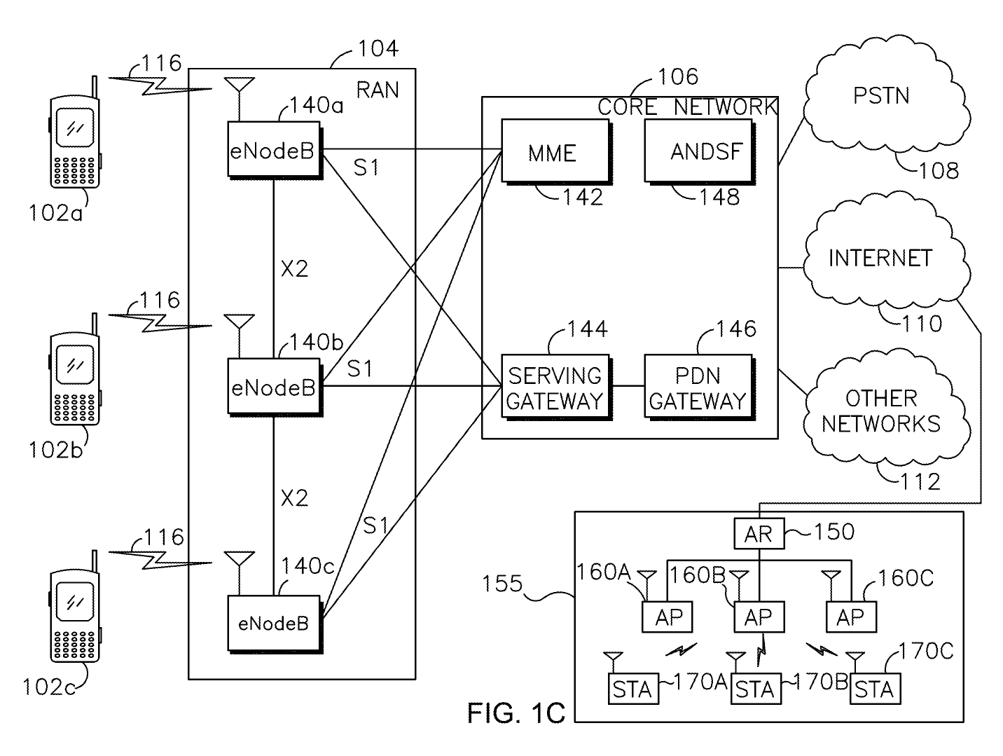

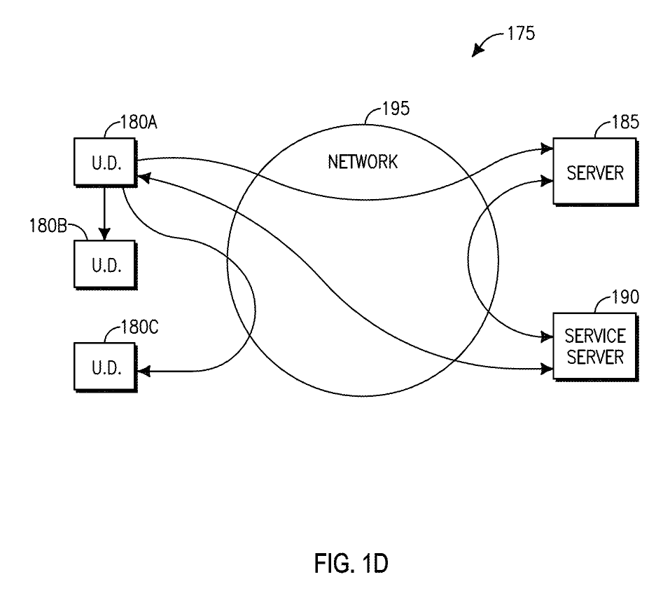

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b may be each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (MAY BE-2000), Interim Standard 95 (MAY BE-95), Interim Standard 856 (MAY BE-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that may be to be transmitted by the transmit/receive element 122 and to demodulate the signals that may be received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that may be not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements may be depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data may be available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices. An access router (AR) 150 of a wireless local area network (WLAN) 155 may be in communication with the Internet 110. The AR 150 may facilitate communications between APs 160a, 160b, and 160c. The APs 160a, 160b, and 160c may be in communication with STAs 170a, 170b, and 170c.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that may be owned and/or operated by other service providers.

FIG. 1D is a system diagram of an example communications system 175 in which one or more disclosed embodiments may be implemented. In some embodiments, communications system 175 may be implemented using all or a portion of system 100 as shown and described with respect to FIG. 1A.

User device 180a, server 185, and/or service server 190 may communicate over communications network 195. These communications may be wireless, wired, or any combination of wireless and wired. Communications network 195 may include the internet 110, core network 106, other networks 112, or any other suitable communications network or combination of communications networks.

User device 180a may include a WTRU (such as WTRU 102a), or any suitable user computing and/or communications device such as a desktop computer, web appliance, interactive television (ITV) device, gaming console (such as Microsoft XBOX™ or Sony Playstation™) or the like. User device 180a and/or applications executing on user device 180a may generate events such as mouse clicks, keyboard strokes, and the like. These events may be processed by user device 180a and/or may be transmitted to another device such as server 185 or service server 190. User device 180a may include a processor, a storage (such as a non-transitory computer readable memory or backing store), a receiver, and a transmitter.

Server 185 may include a web server, application server, data server, or any combination of these or other types of servers. Server 185 may include any suitable server device such as a server computer, personal computer, or the like. Server 185 may host applications accessible to user device 185a. For example, server 185 may include a gaming server hosting a massively multiplayer online game (MMOG), an email server, a web server hosting a website such as a social media website or blog, or other types of servers typically accessible by a user device over a computer communications network. Server 185 may include a processor, a storage (such as a non-transitory computer readable memory or backing store), a receiver, and a transmitter.

User device 180a may access server 185 over computer communications network 175 to interact with services that it provides. For example, user device 180a may access a game server hosted on server 185 to participate in a multiplayer online game. Access of server 185 by user device 180a may be via a client application executing on user device 180a or any other suitable mechanism. In some cases, the server 185 may receive events from user device 180a, or may send events to user device 180a. For example, the server 185 may send an event to user device 180a indicating that additional in-game resources are required for continued play.

Service server 190 may include a web server, application server, data server, or any combination of these or other types of servers hosted on a server device. Service server 190 may include any suitable server device such as a server computer, personal computer, or the like. Service server 190 may be configured to communicate with server 185, for example, over network 195 or any other suitable communications medium. Service server may be co-located with, combined with, or in direct communication with server 185. Service server 190 may include a processor, a storage (such as a non-transitory computer readable memory or backing store), a receiver, and a transmitter.

Service server 190 may communicate with server 185 to provide services, such as third party services, to users of server 185. For example, a subscriber to a game hosted on server 185 may access server 185 from user device 180A and may subscribe to third party services for the game which are hosted on service server 190.

Service server 190 may be configured to receive and/or intercept events transmitted between user device 180a and server 185. For example, in some embodiments server 185 and service server 190 may be configured such that server 185 may send an event destined for user device 180a instead or additionally to service server 190, and service server 190 may send the event or another event, signal, or message to device 180a. For instance, in a case where server 185 includes a game server, server 185 may send an event to service server 190 indicating a requirement of a user of user device 180a, and server 190 may send the event or another signal or message to device 180a indicating that a resource is available to acquire the requirement. In some embodiments, service server 190 may only forward the event to device 180a under certain conditions, such as based on a user preference and/or context information relating to the user of device 180a.

In some embodiments, the functions of service server 190 and server 185 may be implemented using the same device, or across a number of additional devices.

In some embodiments, user devices 180b and 180c may communicate with server 185 and/or service server 190 via user device 180a. For example, user device 180a may forward a notification message from service server 190 to user device 180b via a peer to peer connection and may forward a notification message from service server 190 to user device 180c via network 195. In some embodiments, user devices 180a, 180b, and 180c may form a network, such as a peer-to-peer network, and such network may have a mesh topology, a star topology using user device 180a as a coordinating node, or any other suitable topology. In such embodiments, the peer-to-peer network may operate independently of server 185 and/or service server 190, and may incorporate functionality that otherwise would be hosted by server 185 and/or service server 190, such as functionality described herein.

Everything that follows may, but is not required to be, employed and/or implemented using one or more, or part of one or more of the example systems discussed above.

In practice, data privacy may require business or other organizations to enforce and audit privacy operations in a business process which may include data collection, data release for analysis, and usage of the information.

Regarding data collection, self-regulated privacy compliance policies may be defined for in-private browsing, e.g., with “do not track” options. Mobile app analytic platforms may also prevent application developers from storing usage data that may be used to identify individual users and prohibit data collection practices that use the personally identifiable information, or true identity (“real-ID”) of the user in the collected statistical data.

Regarding data release for analysis, data collected from different sources by different companies may either be published or sold, as user data may be valuable for statistical analysis and data mining. In order to preserve privacy, it may be necessary to hide private user information and/or prevent identification of sensitive information from other demographical and background information. Various methods have been proposed to generate data releases having privacy protection criteria, such as K-Anonymity, l-Diversity, and t-Closeness.

Regarding data analysis, privacy statements from data collection companies often state the intended purpose of the data collection. However, there may be little transparency provided to users on what kind of analyses may be performed on the data, and how much personal information may be identified if the data is correlated with information collected from other sources.

Regarding data utilization, personal information may be used by service providers and third parties to identify an individual's sensitive information. The personal information may also be used as background information to derive sensitive information that may directly or indirectly impact the individual.

Various approaches are discussed herein for providing privacy preserving data collection, analysis, and utilization, and for providing personalized services using dynamic user behavior profiling to improve user experience and customer retention.

Personal information, which may be mixed or interspersed with application data, may be collected, kept, mapped, used, and/or released by entities who provide little or no transparency as to how the data may be used, released, or deleted, etc. Where sensitive information, demographic information, and user behavior data are collected and stored together, it is possible that a true user identity may be revealed and may be used for business purposes that were not expected by the user. Such information may also “leak” accidentally, or be leaked purposely for profit. Further, for many freemium games and applications, users may prefer to play anonymously. As discussed herein, however, it still may be possible for a service provider to provide personalized service to the user without obtaining the user's identity.

In order to realize a privacy-preserving user profiling process, systems, methods, and devices are described herein which address various privacy issues. Such issues may include identifying and verifying anonymous users without requesting the user to provide a unique identifier; preventing linkages or relationships among different types of user data (e.g., personal information, in-app transactions, and user behavior data); tracking and controlling the purposes of data analysis and usage; and delivering personalized services (e.g., customer retention and/or remedial actions to users) without using personal information.

Such privacy preserving user profiling processes may be used to enforce privacy policies and to provide personalized service while achieving anonymity for each regular and anonymous user, as further described herein.

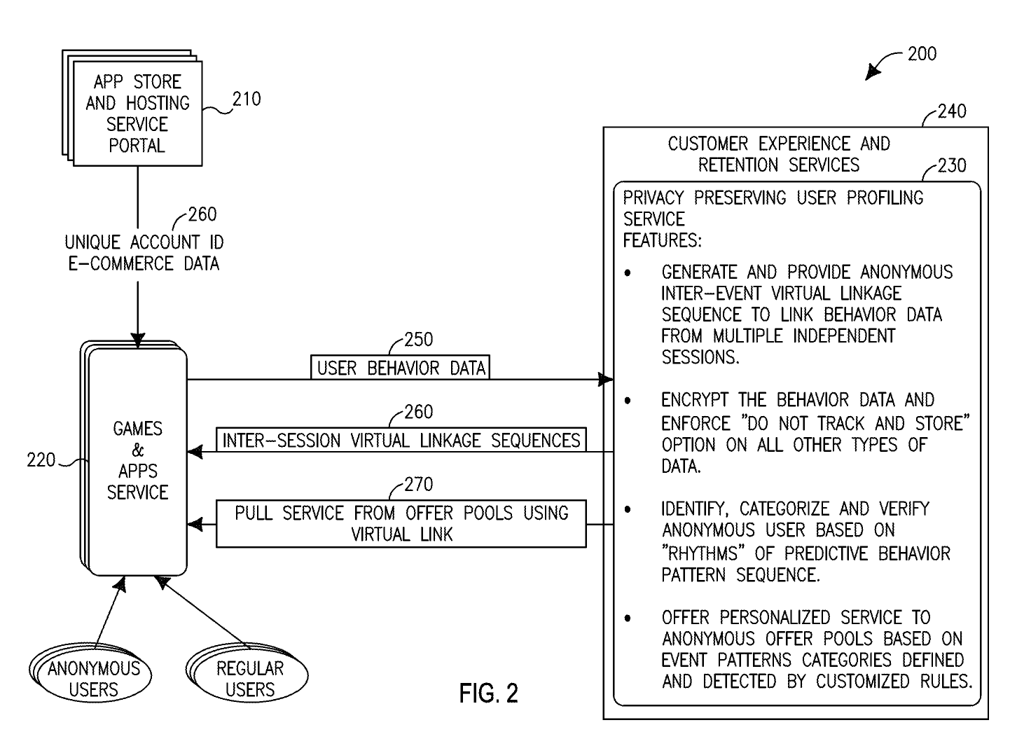

FIG. 2 is a system diagram which illustrates an example system 200 for implementing a privacy-preserving user profiling service. Such privacy preserving user profiling may be provided by a third-party offering customer experience and retention services. The service may interface with game and application services independently from application store and hosting services such as those offered by Google™, Apple™, and Microsoft™.

Users of a game or application may be anonymous users (e.g., who have chosen not to be identified, or who have an unreliable identifier), or may be “regular” (e.g., subscription or otherwise typically non-anonymous) users. Users may also choose different privacy settings. For example, a regular user may wish to remain anonymous for certain freemium apps or games, and accordingly may choose an in-private mode (for example, opting out of tracking by engaging a do-not-track or history-delete feature). System 200 may include various service entities, such as an app store and hosting service portal 210, application and game service 220, and user profiling service 230.

It is noted that privacy-preserving user profiling services may use or incorporate some or all of the components of system 200 in varying combinations without departing from the invention. It is also noted that various components of system 200 may be implemented using part or all of systems 100 and/or 175 as shown in and described with respect to FIGS. 1A-D. For example, hosting service portal 210, application and game service 220, and/or profiling service 230 may be implemented using server 185 and/or service server 190.

App store and hosting service portal 210 may be hosted on a server, such as server 185 and/or service server 190 (FIG. 1D), and may provide or include one or more app/game registration, sale, deployment, and/or hosting management entities (e.g., those provided by Google Play™, Apple App Store™, Amazon App Store™, Windows Apps™ or other such app stores). Apps and games available via portal 210 may be based on HTML5 or based on a native language, for example. In either case (or other cases), portal 210 may provide one or more APIs for either type (or other types) of application. These APIs may be used to access services provided by portal 210. Anonymous user identification management may be one service, possibly among other services or a set of services, provided by portal 210. Portal 210 may also provide analytic and/or monetization service APIs to either type (or other types) of applications.

Game and app service 220 (e.g., a massively multiplayer online game or “MMOG”) may be managed by an application/game developer, and may be of one of various types.

In a first, server-centric type, a server may host all (or most) of the application or game logic, and client devices may only collect user inputs and display pages or frames of images sent from the server. The app or game service 220 (in this case, based primarily on a server) may use data collection APIs provided by either portal 210 or a third-party to send data (e.g., user behavior data 250) to one or more corresponding analytic services (e.g., profiling service 230). In this example, customer experience and retention service 240 may be a third-party service, which may provide data collection APIs for the application and game server developer to configure app or game service 220 to send data (e.g., user behavior data 250) to its service endpoints (e.g., profiling service 230).

In a second, client-centric type, all (or most) of the application or game logic may be executed by a client device (e.g., a mobile device). Client-side application or HTML scripts may thus provide most of the application functions and interactions with the user. The game and app service 220 (in this case, based primarily on a client device) may use portal 210 APIs (e.g., Google™ or Apple™ developer kits) to obtain a user identification 260 from the portal 210, and to send data (e.g., user behavior data 250) to one or more corresponding analytic service endpoints (e.g., profiling service 230) directly, or routed through proxy servers of the third-party analytic service endpoints that may be co-located with the hosted application and game service 220. A client application may also use APIs provided by third-party analytic service endpoints (e.g., profiling service 230). Third-party analytic service endpoints themselves may be co-located with a hosted app/game server (e.g., via portal 210). Various suitable topologies for arranging these elements are possible.

User profiling service 230 may be hosted on a server, e.g., by a third-party service provider. Profiling service 230 may be one of a number of customer experience and retention services 240 provided, e.g., by the third-party service provider. Profiling service 230 may provide an API to app/game service 220, through which it may collect data (e.g., user behavior data 250) from the app/game service 220. The application and game server or device that generates the data may be referred to as a data source. The service server that collects data from the data source may be referred to as a data collector. The collected data may be used for improving customer experience and retention. Because app/game service 220 may not be able to use a real user identification, (e.g., from portal 210), app/game service 220 may include options for creating a new local identification, or to rely only implicitly on a user identification provided by portal 210.

In the first case (application-specific user identification), app/game service 220 may provide a user registration and login function and may mange user identification in an application server or client application, depending upon where the identification management server function resides. The app/game service may include options for sending a local identity to a third party, or for keeping the local identity anonymous. An individual user identity may not be required, for example, for providing a user-independent aggregation report to the third party. However, for personalized service, it may be necessary to identify critical behavior patterns which require the service provider's attention in order to improve the experience of the individual user exhibiting that behavior. If the app/game service 220 does not send a local identity to the third party, or has strict requirements for privacy protection of the user identity and data, it may be necessary for enhanced privacy preserving profiling methods to be provided by the third party.

In the second case (no local identification), privacy may be better preserved when connecting to a third party analytic provider (e.g., using an analytic software development kit provided by the third party). In this case, the profiling service 230 may be required to provide support for anonymous users when collecting large amounts of in-app user activities.

To provide enhanced privacy for different types of users and privacy configurations, the user identity or other types of tracking information may not be assumed to be provided to the profiling service 230. Furthermore, to support “do not track” and “opt out” privacy policies, the profiling service 230 may only collect data released by the user to derive predictive behavior data anonymously. The predictive behavior data may be used for providing personalized service. For the purpose of data usage transparency, the set of collected data, derived predictive behavior pattern and the personalized service using the data may be described in a privacy policy statement by the service provider

Various features of profiling service 230 may include anonymous event identification; behavior data encryption; no-track-and-store enforcement; identification, categorization, and verification of anonymous users; and anonymous offer pools.

Anonymous events may be identified as belonging to the same customer by providing inter-event, or inter-session, virtual linkage sequences 260 to link anonymous user behavior data 250 from multiple independent sessions. This may achieve anonymous data collection without depending upon any externally defined user identification.

Behavior data may be encrypted, and no-track-and-store options may be enforced on all other types of data, such as contact information. This may have the advantage or reducing the potential risk of user identities leaking via correlation of behavior data to other external sources of data.

Anonymous users may be identified, categorized, and verified based on “rhythms” of predictive behavior pattern sequences. It is noted that in this context, identification does not reveal a “true” user identity, but identifies a user for purposes of creating a behavior profile which is not linked with the true user identity. Such identification, categorization, and verification of anonymous users may include extracting “signatures” from the rhythms. These signatures may be used to provide fast, content-based search to identify similar behavior event patterns among a large set of user behavior data. Signatures may include multiple time-series vectors. Such time-series vectors may permit matching of unique patterns from among the user data. For example, it may be unlikely for two users to start a particular event (e.g., a section of a game) at the same millisecond (or other suitably fine unit of time), or at the same time more than twice, for example. In another example, it may also be unlikely for two users to have the same length of play and/or attributes in skill vectors. Combinations of these may increase the certainty of identification of the signature.

It is noted that the signature may include historical and/or predicted rhythms. If predicted rhythms are used as signatures, the prediction accuracy may affect the accuracy of the match of newly collected signatures from anonymous users. Poor accuracy, in this regard, may result in false positive correlations of signatures to anonymous users.

Certain uses of event patterns may not require matching an anonymous user. For example, it may be sufficient to identify a predictive pattern to offer a personalized service. For example, in order to offer personalized help to a user in a gaming context, it may be only necessary to know that the user is a beginner and has low score for many sessions of the game or other similar games. In this case, a personalized service may be simply a tutorial for beginner. Other uses of event patterns may require verification of further details of the user. In such cases, the historical rhythm or signature may be used to verify an anonymous user. For example, it may be necessary to determine the scores attained and improvements made by an anonymous user during the past few weeks to decide if the user should be provided with a promotional item or awarded with a prize for higher accuracy. Thus, in this case it may not be necessary to identify a particular anonymous user, but rather, other details about the user.

Anonymous offer pools may be made to users to provide personalized service. Such offer pools may be based on event pattern categories, which may be defined and/or detected using customized rules. In such offers, no direct notification may be sent to an anonymous user; rather, the application or game may use the data collection inter-session virtual linkage sequences 260 to pull a service offer 270 from a service offer pool. A virtual linkage sequence may be a linked list of dynamically generated virtual identifiers for each behavior data set from a user and structures for storing uniform resource identifiers (URIs) for service offers. Service providers may insert personalized service offers into a service offer pool, which may store multiple service offers for “multiple” anonymous users. An application may use the virtual linkage sequences to retrieve the virtual identifier for a specific subset of behavior data and URI. Using the URI, the application may “pull” the service offers from the pool.

Various privacy preserving methods are further described herein. Privacy preserving user-profiling service 230 may use one or more of the following techniques, or other techniques, to enhance privacy protection in different stages of a user profiling process.

A Virtual Profile Identifier (VPI) may be defined to identify a user behavior data set without using a user identity associated with personal or demographical information. A VPI may be or include an anonymous identifier generated from summary data derived from the contents of a behavior data set collected from an anonymous user. Since each user's behavior data set contains a large amount of multiple dimensional time series vectors, it may be sufficient to generate identifiers that may uniquely identify each data set with minimal collisions. A VPI may thus be used as a content-addressable field of the collected data set to support efficient storage management of multiple data sets from a large user community. For example, a VPI may be derived from a summary of statistics collected from a large set of behavior data which includes game session time, win-loss score, and user's skill level assessments (e.g., reaction time, accuracy, strategy, and avatar control). It may be unlikely for two players to have played at the same (or sufficiently similar) time, duration, win-loss score, and skill level assessments.

Predictive VPI chaining may also be used (e.g., for tracking isolated gaming behavior or metrics data sets). Because the contents of the user behavior data set may change overtime, a VPI generated from the data set may also change over time. In this way, a set of VPIs may be generated to identify the history and predicted trends of each player's data set. This set of VPIs, and the data set, may be self-contained, and therefore, may be isolated without dependency or linkages to other sources of information (e.g., demographic) which might reveal a personal identity or other sensitive data correlated with the user. Furthermore, since user interactions with mobile apps and games may be sporadic, the set of VPIs of a single user may be chained together and shared between the data source (e.g., mobile app and game) and the data collector. This may be done to maintain a continuous history of the data set.

One example of such chaining may include a linked list of predictive VPIs generated from predicted trends of a user behavior data set over time. The data source, which may be application or game services or devices, may keep track of the most up to date VPI linked list, and may use the VPI linked list to resume the data collection operation. The VPI link list may be generated by the service server and may be used by the service server to access behavior data set for each user. However, if the link is lost (e.g., due to crashes or reinstallation of applications or deletion of local copy of the VPI linked list), the data collection process may attempt to reestablish the linked list by collecting a new set of user behavior data and comparing it with previously stored predictive trends to find the best matching data set from a set of disconnected data sets, and to thus continue the anonymous data collection process.

Anonymous behavior data analysis may be used to provide personalized services. For example, various types of personal services may be recommended to be offered to users based on trending analysis of event patterns derived from behavior data collected from the users. To provide additional levels of privacy protection for the personalized service, the access to methods used to analyze historical behavior patterns and to generate predicted behavior patterns may be controlled. The predictive patterns and a summary of actual events may be defined as a “signature” of the behavior data set. The scope of the analysis may be controlled by this signature, and, especially the predictive portion of the signature. For example, the play time distribution of a user during the past few months may be used to generate predicted a play time distribution for the next few weeks. An achievement score, which represents a summary of each game session, may also be part of a controlled behavior pattern associated with the user. The controlled user behavior pattern may be listed in a privacy agreement of the service provider. In addition, context sensitive information that may be used to identify a user may be masked, mapped, and/or encrypted to preserve anonymity. Only “authorized” or controlled analysis methods may be permitted to access the data set when using the VPIs for different sections of the data set.

Data may be utilized for personalized services. The predicted behavior patterns of a user may be used by a set of rule engines to determine one or more (or a set) of remedial actions, which may be tailored for each user. The remedial actions may implement personalized service offers. The profiling service 230 may not however “reach” out to the anonymous users, because their contact information may be isolated. For privacy reasons, the offers 270 may be not directly provided to the end users, e.g., to avoid creating the perception of being probed or interrupting the user's normal operation. The personalized service offers 270 may thus be labeled with reasons and/or VPIs which the app/game service 220 may pull from the profiling service 230, and may be presented to user with minimal intrusion, possibly at session break for example. If the user accepts offers which require verification of their identity, e.g., for e-commerce transactions, separate business processes may be launched to grant and record the transaction using personal information. Furthermore, to enforce the usage of personal data as defined in a privacy statement, the business purposes of any linkage to e-commerce or other business processes may be accepted and logged when users receive the granted offers 270.

Encryption of chained historical data and predicted data signatures may also be employed. For example, the historical behavior data may be encrypted using the VPIs as part of an encryption key. If a VPI is leaked, data may not be generated from the VPI, and user may not be identified from VPI. If both the user behavior data set and VPI are both leaked, only the section of the data set controlled by the VPI may be revealed. It is noted that IP addresses or other personal identifiers may not be correlated or stored with the user behavior data.

The isolated VPIs, event pattern signatures, and predicted event pattern signatures described above may have the advantage of facilitating a privacy preserving user profiling process which may include
a) Identifying and tracking signatures of anonymous user behaviors without using other information that may be not related to the intended personalized service based on use behavior data.
b) Deriving a content addressable VPI from a signature of the behavior data set to support efficient data management and encryption.
c) Dynamically changing VPIs as the behavior data set changes. VPI chaining may thus support behavior data set tracking over multiple sporadic sessions.
d) Linking and encrypting, using the VPIs, access to VPIs and the data set. This may facilitate privacy policy enforcement.

Methods to generate and track behavior signatures are described herein. Such methods may be used to generate a multi-resolution signature of user behavior data that may be used to identify user behavior patterns and/or to derive VPIs. In addition to mobile applications and games, such methods may be used to support multi-resolution user profile filtering and other types of profiling applications.

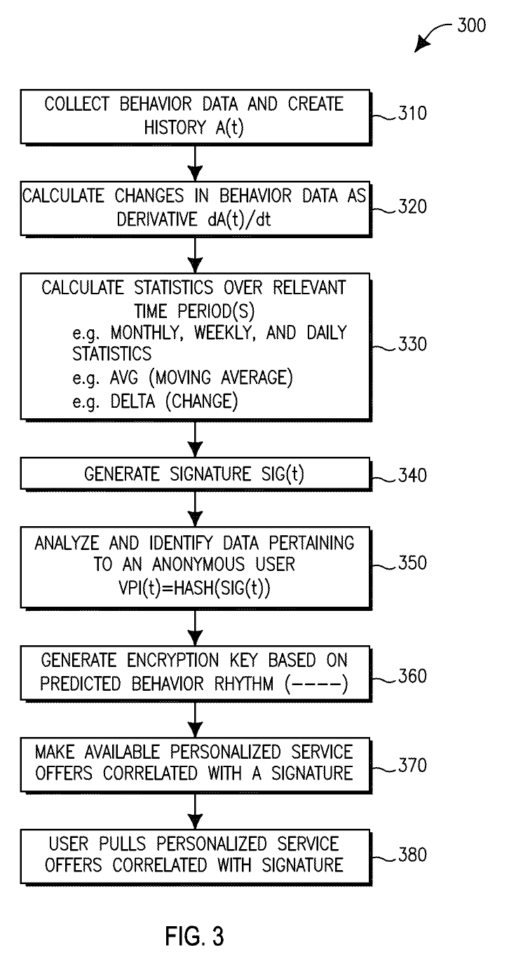

FIG. 3 is a flow diagram which illustrates aspects of an example method 300 for extracting a time-varying signature. In step 310, user behavior data is collected. User behavior data may be collected by service 220 and forwarded to service 230. This user behavior data may include one or more player attributes, for example, and may be expressed as A(t). In step 320, changes in the behavior data are calculated. These changes may be calculated as the derivative of the behavior data, (e.g., dA(t)/dt). This calculation may be carried out by service 230, for example. In step 330, statistics regarding the behavior data may be calculated over a relevant time period. For example, a moving average and/or change (delta) of the behavior data may be calculated. This calculation may be carried out by service 230, for example. In step 340, a signature of an anonymous user may be derived from the behavior data. This calculation may be carried out by service 230, and may be expressed as Sig(t). In step 350, a VPI may be generated for the anonymous user based on the signature, e.g., as a hash of the signature. This calculation may be carried out by service 230, and may be expressed as VPI(t)=Hash(Sig(t)). In step 360, an encryption key may be generated using VPI as part of the input parameters. Service 230 may carry out this generation. In step 370, a personalized service offer may be made available, correlated with the signature. This may be handled by service 230. In step 380, a user (or client service/device) may pull the personalized service offer based on the signature. Service 220 may pull the personalized service offer from service 230 using virtual link 270, for example.

Table 1 describes the method 300 as shown in FIG. 3 in further detail.

TABLE 1
Generation of Privacy Preserving Virtual Profile Identifier (VPI)
signatures

| Profiling Stages | Function Descriptions | Notes |
|---|---|---|
| Step 310: | A(t) = [A₁(t), A₂(t), . . . Aₙ(t)] | Reaction time, |
| Collect Behavior | History of A, | accuracy, win-loss |
| Data and | A_{history} = {A(tₙ), A(tₙ₋₁), . . . | score, and play |
| History | A(t₀)} | schedule and duration, |
| | Assume that all the values | are examples of |
| | of attributes have been | possible attributes. |
| | normalized to [−1, 1] | |
| Step 320: Calculate | $dA ( {t}_{n} ) = \frac{A ( {t}_{n + 1} ) - A ( {t}_{n} )}{{t}_{n + 1} - {t}_{n}}$ | The derivative of the attributes value may |
| derivative of | dA_{history} = {dA(tₙ₋₁), | be used to track |
| A(t) | dA(tₙ₋₂), . . . dA(t₀)} | changes.. An |
| | Insert 0 if there may be | alternative method |
| | missing samples. | may include using a |
| | | relative ranking with a |
| | | set of anonymous |
| | | players” to “percentile |
| | | ranking against a |
| | | distribution model |
| | | derived from a set of |
| | | behavior data from |
| | | other anonymous users. |
| Step 330: | AvgAₘₒₙₜₕ(i) i = 1, . . . M | In this example, multi- |
| Calculate | AvgA_{week}(i) i = 1, . . . W | dimensional and multi- |
| monthly, weekly | AvgA_{day}(i) i = 1, . . . D | resolution time series |
| and daily stats | dAₘₒₙₜₕ(i) i = 1, . . . M | are mapped onto a |
| (e.g., moving | dA_{week}(i) i = 1, . . . W | calendar of events to |
| average and | dA_{day}(i) i = 1, . . . D | form “rhythms” of |
| change) | | event patterns. |
| Step 340: | Sig(t) = | In this example, |
| Generate | [dA(tₖ), AvgA(tₖ), tₖ], . . . | signatures are |
| signature | [dA(t_{K}), AvgA(t_{K}), t_{K}] | generated from the |
| (e.g., extract | for k = 1, . . . , K | summary or subsets of |
| dominant | Note that Sig(t) at time t | dominant, repetitive or |
| coefficients from | may contain elements Aₖ in | abnormal elements in |
| month weekly | the history data or in the | monthly, weekly and |
| and daily stats) | predicted data. | daily event patterns. |
| Step 350: | VPI(t) = Hash(Sig(t) ) | The signature may be |
| Data Analysis | Store [VPI(t), Sig(t)] in a | used to derive VPIs |
| and | multi-resolution data cube | and used to provide |
| Identification | with monthly, weekly, and | fast access control to |
| | daily calendar entries, | collected data set and |
| | | the predicted behavior |
| | | rhythms stored in a |
| | | data cube. |
| Step 360: | Generates encryption key | Server and separate |
| Authentication | using predicted section of | service application |
| and behavior | behavior rhythm (e.g., VPI) | stores the signatures |
| data protection | without linkage to real | and VPIs. VPIs may |
| used for | user identification based | be used to authenticate |
| personalized | key management. | the user and provide |
| service | Both user and data | fast access to the data |
| | collection entities may be | set. |
| | informed and the history | |
| | data may be decrypted | |
| | only when needed. | |
| Step 370: | Provider provides | User personal |
| Anonymous | personalized service to | identification may be |
| pulling of the | Sig(t). | only revealed to |
| personalized | User selects personalized | separate e-commerce |
| service offers. | service offer using Sig(t). | transaction, keeping |
| | User accepts service by | analysis process and |
| | providing e-commerce ID. | the contents of the |
| | Personalized service | personalized service |
| | offered based on Signature | offer private. |
| | but service may be only | |
| | granted using real user ID | |
| | (e-commerce ID). | |

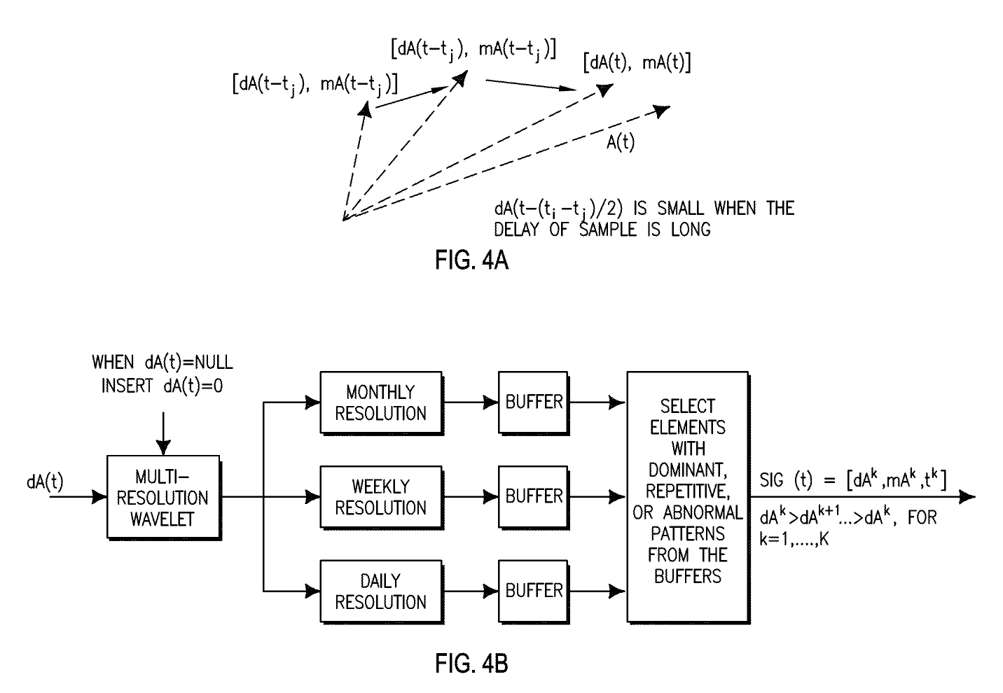

FIGS. 4A and 4B are a vector diagram and flow diagram respectively which illustrate various aspects of extracting a time varying signature in accordance with aspects of method 300 as described with respect to FIG. 3, and other aspects described herein.

Methods to predict and encrypt behavior data are described herein. For example, such methods may include tracking and predicting anonymous user behavior, and identifying a particular anonymous user based on the prediction. This identification may not entail or require identifying the true user identity, but rather, identifying the particular user from among the set of anonymous user behavior data, both historical and predicted. Dynamic user behavior data may include, for example, a skill level profile of the playing performance of a user, such as win-loss scores, game session profiles, and may include context information, such as a session timestamp.

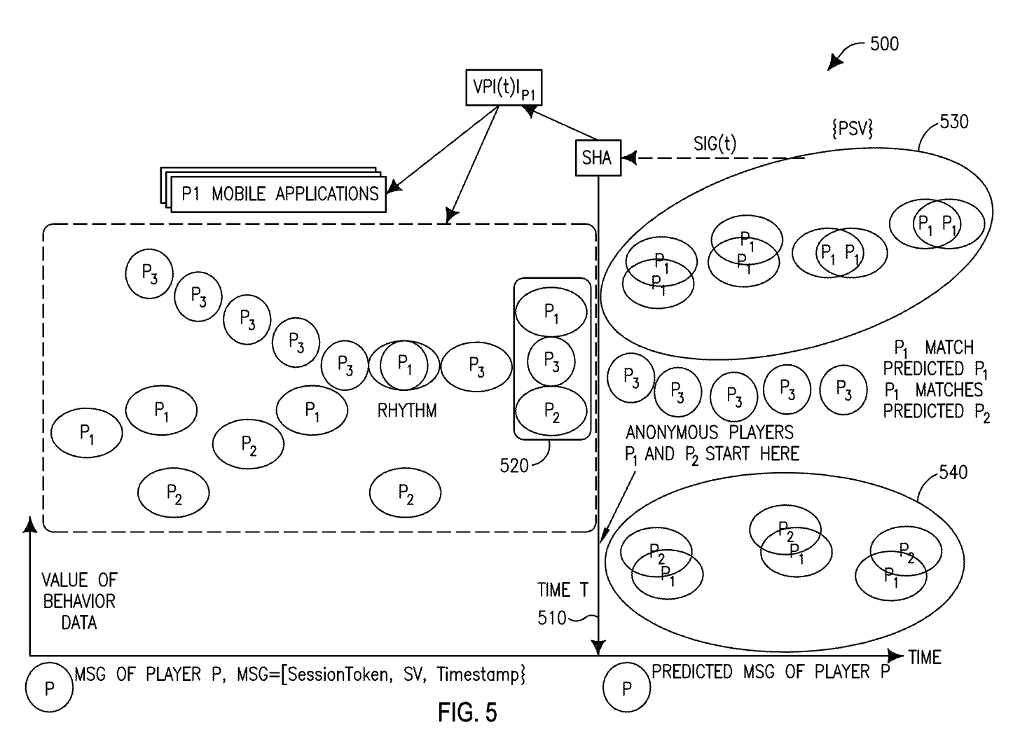

FIG. 5 is a graph 500 which illustrates example “rhythms” of the play event patterns of three players P₁, P₂, and P₃, plotting historical and predicted behavior data over time. Behavior data may include, for example, a skill level or other attribute, a vector of such attributes, and/or a win-loss ratio. In FIG. 5, the behavior data is defined as zero at times during which the player is not playing.

When each player completes a game session, behavior data from the session may be aggregated, analyzed, and stored in a data cube. Storing the behavior data in this way may provide fast access to stored data based on time and other user defined parameters. The stored data may be used to develop predictions about the future behavior of users, and to correlate newly acquired data with these predictions to identify anonymous users.

For example, as shown in FIG. 5, it may be observed that P₁ tends to play two sessions together with a break in between, as reflected by the groupings of P₁ data along the time axis. It may also be observed that P₂ tends to play regularly but with fluctuating behavior data (e.g., win-loss score) as reflected by the regular spacing of the P₂ data along the time axis, and the varying values of the P₂ data along the vertical axis. It may further be observed that P₃ plays regularly, intensively, and with steady behavior, as reflected by the close and regular spacing of the P₃ data along the time axis, and the smooth progression of the P₃ data with respect to the vertical axis.

Axis 510 indicates a point at a time t, before which the behavior data for P₁, P₂, and P₃ is historical, and after which the behavior data for P₁, P₂, and P₃ is predicted. Anonymous players Pᵢ, and Pⱼ may begin playing the game without announcing their identity to the game service provider. Behavior data for Pᵢ, and Pⱼ may be collected, analyzed, and compared with all the predicted user behavior data sets for all the users. Historical data for two anonymous users Pᵢ, and Pⱼ is shown after time t in graph 500.

In this example, the behavior of P₁, P₂, and P₃ is similar in area 520, prior the time t. The predicted patterns of P₁, P₂, and P₃ are different however, based upon the historical data prior to area 520. In this case, after observing Pᵢ and Pⱼ for multiple sessions (e.g., observations 530), it is evident that the behavior of Pᵢ is correlated with the predicted behavior of P₁. Similarly, it is evident that the behavior of Pⱼ is correlated with the predicted behavior of P₂ based on observations 540. Accordingly, using predicted behavior may provide an accurate base of player behavior for matching changing user behavior patterns.

Predicted behavior patterns may also exhibit rhythms in a data cube. For example, a player may play every weekend from 2 to 5 pm and may only play short session during lunch during weekdays. Another player may play every night from 10 to 12 pm. This calendar-based play schedule may be combined with user behavior data such as skill level and win-loss score to assess “rhythms’ of event behavior patterns that have magnitude in multi-dimensional space which repeats and changes over time. Such rhythms may provide rich information for identifying user behavior data accurately without using or correlating a unique user identity or other sensitive information.

To build the prediction function, time series models may be employed to study player gaming behavior. Specifically, for each single player, historical skill vectors may be collected and updated with timestamps. The time series model may be trained based on this historical data to predict the unknown skill vector after a specific time point. For example, in FIG. 5, there are 5 skill vector updates before time t for P₁. Based on these 5 skill vector values, with timestamps, time series models may be built to predict the skill vector values for P₁ after time t. Once the predicted skill vectors (PSVs) for P₁ are obtained, the PSVs may be compared with anonymous skill vectors (e.g., Pᵢ). Based on the comparison, anonymous players may be inferred or otherwise recognized. For example, the anonymous player Pᵢ may be recognized as P₁ based on the correlation between collected data for Pᵢ and predicted data for P₁.

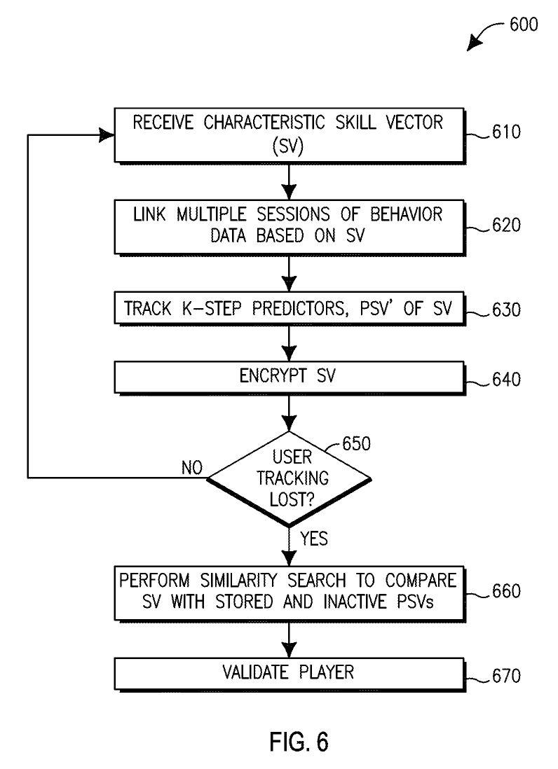

FIG. 6 is a flow chart which illustrates aspects of an example method 600 for tracking anonymous users by generating predicted skill vectors (PSVs). In step 610, a characteristic skill vector SV of a player is received. Characteristic skill vector SV may be received from a data source (e.g., game server) by a service server, for example. In step 620, multiple sessions of behavior data are linked based on the received SV. This linking calculation may be performed by the service server, for example. In step 630, k-steps predictors, PSV, of SV, are tracked. This tracking may be performed by service server for example. In step 640, the SV is encrypted. On a condition 650 that user tracking is lost, e.g., that a received SV is not tracking a user as predicted, a similarity search is performed to compare SV with stored and inactive PSVs in step 660. This similarity search may be performed by the service server. Otherwise, tracking may continue at 610. In step 670, the player identified in the similarity search may be validated. For example, the most plausible unclaimed track (i.e., the PSV most similar to the received SV. This validation may be performed by the service server.

Table 2 lists example behavior data which includes user skill level defined over a set of dynamic changing attributes. Examples of such attributes include such as reaction time, accuracy, virtual session VPI tokens, and time stamps. It is noted that session information related to user IP address and/or port, or other information which may be used to reveal a true identity of a user, may not be used in the data collection process. The VPI token may be derived from VPI (e.g., the Link ID of the VPI chain), or an anonymous token may be initially assigned until the VPI is generated.

TABLE 2
Tracking of Anonymous Users

| | Function | |
|---|---|---|
| Tracking Stages | Descriptoins | Notes |
| Steps 610, 620: | SV = {SV₁(t), | SV may be obtained from Skill |
| Receive a | SV₂(t), . . . SVₙ(t)} | Calibration Rule Engines which |
| Characteristic | MSG = | collect the user behavior from |
| Skill Vector, SV, | {VPITtoken, SV, | the data source to generate and |
| in a message | Timestamp} | adjust SVs for one or more |
| stream with a | | game sessions. Note that SV |
| VPIToken and | | may be normalized. SV may be |
| link multiple | | normalized similarly to the |
| sessions of | | attributes described herein |
| behavior data | | regarding signature generation |
| based on SV. | | section. |
| | | The linkage between VPIs for |
| | | each of the sessions may be |
| | | implemented using a list |
| | | structure with bidirectional |
| | | links. The link may include a |
| | | unique URI or key string. |
| Steps 630, 640: | {PSV} = | Store the PSV and a history of |
| Track k-step | PSV′(t + 1), . . , | MSG over a time window. |
| predictors, PSV′ | PSV′(t + k)} | The k-step predicators use the |
| of SV | Encry(SHA(PSV), | history data to predict k future |
| Encrypt SVs | {SV(t),..,SV(t-w)}) | values using statistical methods |
| using MD5 or | Store [VPI(t), | such as an Arma model or |
| SHA of a | encrypted{SV(t), . . , | Kalman filter. |
| selected PSV′ | SV(t-w)}]] and | A hash value may be generated |
| | [VPI(t + k), {PSV}] | from {PSV} and used to encrypt |
| | in data cube. | a window of the history. |
| | | The service provider may also |
| | | encrypt or keep the encrypted |
| | | {PSV} and store it with VPI in |
| | | data cube. |
| Steps 650, 660: | {VPI} = | If the set of VPI Use context |
| If user tracking | {VPIToken, SVs, | information (e.g., timestamp |
| is lost, perform a | Timestamp} = k- | and location) to compare the |
| similarity | NN({SVs}, PSV)) | behavior of anonymous users. |
| search | | |
| comparing SV | | |
| with stored | | |
| inactive PSVs | | |
| Step 670: | Verify player | Assign the most plausible un- |
| Validate player | provided SV with | claimed track to the anonymous |
| by collecting the | {VPI.SV} → | player. |
| SVs history, or | Recover the track | |
| via manual | | |
| query | | |

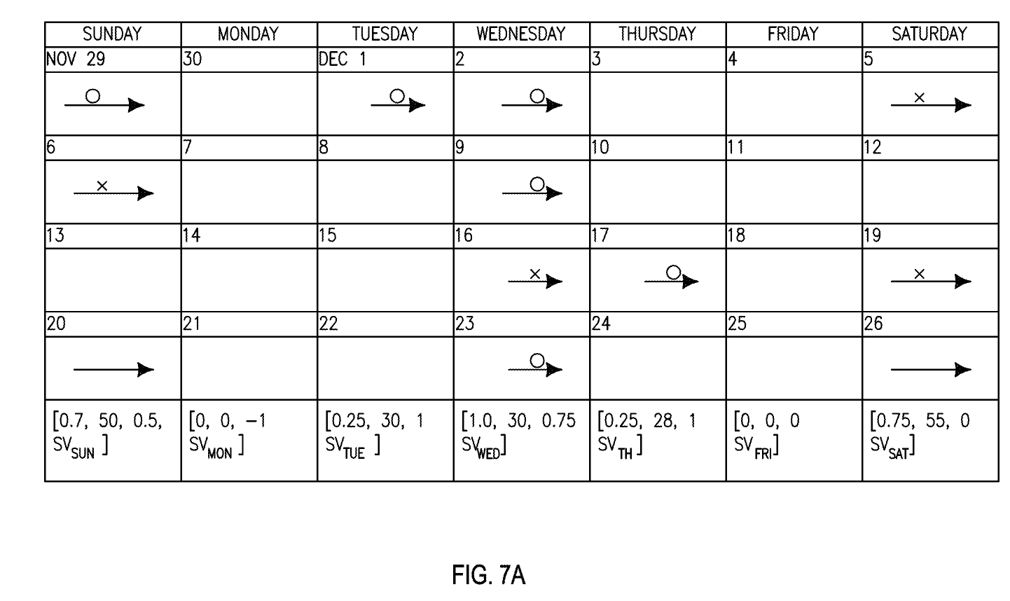

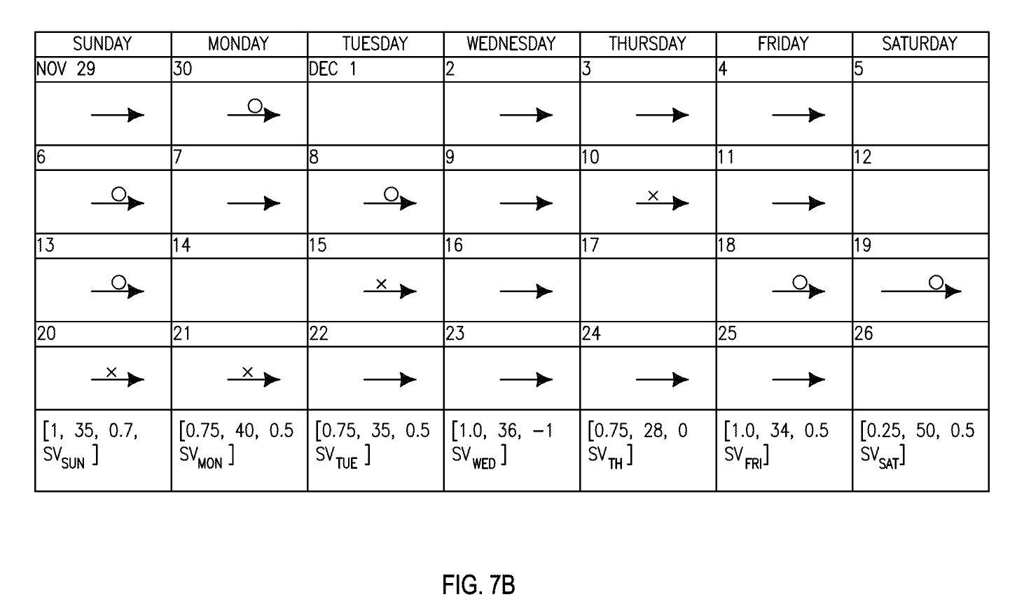

FIGS. 7A and 7B are calendars which illustrate example signatures derived from game session play time, duration, and win rate, and skill level assessment vectors of behavior data sets over a month. In this example, each arrow in the calendar represents a game session and the length of each arrow represents average duration played in one day. The bottom row of each calendar shows monthly summary statistics. These statistics are expressed as signatures which include [Pr, D, O/X, SV] for the month. Here, Pr represents the probability that the player will play on that day of the week. D represents the duration of play time, expressed in minutes in this example. O and X represent wins and losses respectively, or win percentages greater than and less than 50% respectively, for example. O anc X may also represent a winning percentage. It is noted that some game sessions may not have win or loss records. The signatures represent a summary of distinct rhythms shown in the calendar. These signature rhythms may be stored in a data cube.

The calendar of FIG. 7A shows a rhythm signature for a first player, and the calendar of FIG. 7B shows a rhythm signature for a second player. Quarterly statistics may be derived from the monthly data to identify frequent players, and/or good players who have high win rates. For example, the winning percentage may be calculated for each week day may be aggregated to obtain a monthly winning percentage. There may be sufficient information to distinguish the two rhythms. For example, the first player may play more frequently on Saturday and for a longer playing duration on Sunday than the second player.

The signature rhythms described with respect to FIGS. 7A and 7B may be used as parameters which may be input to a rule engine to detect event patterns and generate suitable remedial actions. For example, pseudo code is shown below for a rule to detect a good player who has many (i.e., above a desired threshold) wins in the past but who has lost three times in the last three days. The pseudo code also describes generation of a remedial action, e.g., checking whether there are network problems.

//Declare
monthlyRhythm = [VPI, Pr, D, MonthlyWinRate, MonthlySV]
dailyRhtythm = [VPI, Pr, D, dailyWinRate, dailySV]
//Assume that monthly rhythm may be inserted in the rule engine.
//The daily rhythm may be inserted to the rule engine in real-time as
stream of events.
Rule “Frequent Winner Loss Detection”
Ruleflow-group “EventDetectionRuleGroup”
when
count((monthlyRhythm.WinRate − dailyRhythm, dailyWinRate) > 0.2 ) >
3, in (time window of 7 days)
then
Alert (“Reason: Frequent Winner Loss Detection rule fired”, Do
something using user behavior profile data identified by VPI”)
End

The rule described above is for exemplary purposes, and it is noted that various rules may be defined. The Alert statement in the pseudocode above may call a remedial action rule to provide a suitable personalized remedial action.

Methods for managing user behavior rhythm in a data cube are described herein.

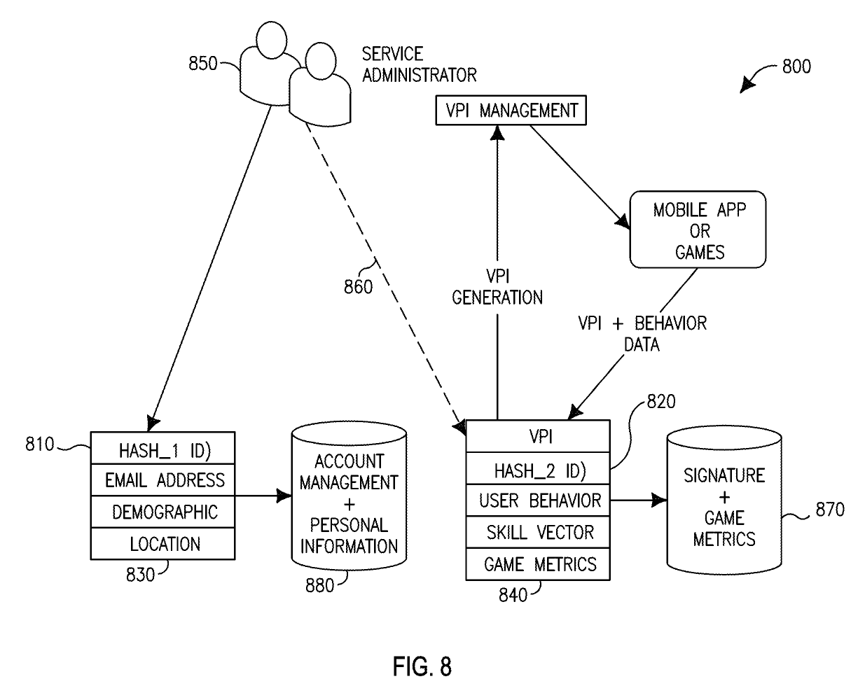

FIG. 8 is a block diagram illustrating an example system 800 for supporting an analytics function while preserving users' privacy.

In the various approaches to privacy preserving user profiling discussed herein, user-related personal information (e.g., account ID, demographic, email address, transaction information, etc.) may be isolated from game related data (e.g., user gaming performance, user behavior data, game metrics, etc.) in order to prevent the true identity of the user from being revealed or inferred by analyzing their gaming activity. To this purpose, the system may separately store the user personal information and gaming behavior data in separate, isolated data cubes 820 and 830 respectively. Data cubes 820 and 830 may be stored in separate account management and personal information database 880 and signature and game metrics database 870 respectively. In this way, there may be no linkage between the behavior rhythms and sensitive user information such as demographic or e-commerce information.

This data separation design may have several benefits. First, the design may address players' concern that a game provider may obtain their identification information (internal threat). Second, because user identification information and game metrics or skill vectors may be stored separately, it may prevent integration and abuse of user information (external threat).

Implementing such anonymous information storage in separate data cubes, may create several problems. For example, when users play a game, it may be difficult to decide which metrics file to update, as all the owners of the metrics files may be anonymous. This may be addressed using the VPI described in any of the embodiments described herein.

Further, game analytics may not link user behavior data to user identification data for making group analyses. Accordingly, if service providers or game developers require the user behavior data for auditing or other business purposes based on known user IDs (e.g., account ID), an administrator 850 with special privileges may be granted access to the behavior data (e.g., data cube 840 and/or signature and game metrics database 870). A one way linkage 860 may be provided to the behavior data. One way linkage 860 represents that there is no link or reference stored in the user behavior data that may be used to access the personal identification information. If behavior data privacy must be enforced, the mapping from account ID to the set of behavior data must preserve anonymity.

Anonymous IDs may be stored (instead of real account IDs) as an index to the data cubes. For example, each player may be assigned with 2 hash functions to convert account ID into two unique hash values. These 2 hash values 810, 820 may serve as indices to user information data cube 830 and game behavior and metrics data cube 840, respectively.

If a player plays the game, the user profile may be updated in the database 870 based on VPI and the VPI may be combined with a hashed ID, Hash-2(ID) 820, as secondary index which may only be used by administrator 850.

Implementing analytics may also create several problems. For example, it may be difficult for game analytics to link demographic information with metrics data in analysis to infer users' characteristics and habits by their demographic group or other user profiling group. It may also be difficult for game providers to deliver customer retention actions to specific players (e.g., via email or other messaging) accurately, as email addresses and game metrics may be stored in different databases (e.g., databases 870 and 880) and no linkage may be provided.

To support anonymity, Hash-2(ID) 820 may provide a coarse index, which may map to at least k VPIs (or user's behavior data). A group hash-id match may be used instead of an exact hashed id match. For example, three players with similar demographics (e.g., age), may each have two hashed IDs, Hash_1(ID) and Hash_2(ID), for indexing data in identification data cube 830 and game behavior data cube 840, respectively. System 800 may only provide the knowledge that three personal identifiable information for users with Hash_1(ID)s in identification data cube 830 may be matched to the three behavior data with the same Hash_2(ID)s in game metrics data cube 840 instead of an exact one to one match between user's identification information and behavior data . . . . This approach may have the advantage of reducing the risk of inferring a true user identification.

In order for game providers to perform a customer retention action (e.g., offering an incentive or higher level of service), based on detected abnormal user behavior data for example, it may be necessary to match game metrics data (e.g., events such as game ID, session ID, session start time, end time, scores, kills, fails, and prizes earned, stored in data cube 870) to specific email addresses or other identifying information (e.g., which may be stored in the other data cube 880). To this purpose, system 800 may attach the customer retention actions to the game metrics data (e.g., in database 870) if it is found that the anonymous user needs a retention action. Thereafter, the app on the client/player device may periodically fetch or “pull” the customer retention actions. If one or more customer retention actions are available, the app may fetch available actions without the need for the game providers to know their true identification. The system 800 may also or alternatively provide a third party or isolated web service that allows for retrieval of accepted personal remedial actions by using an actual (e.g., true or non-anonymous) user ID.

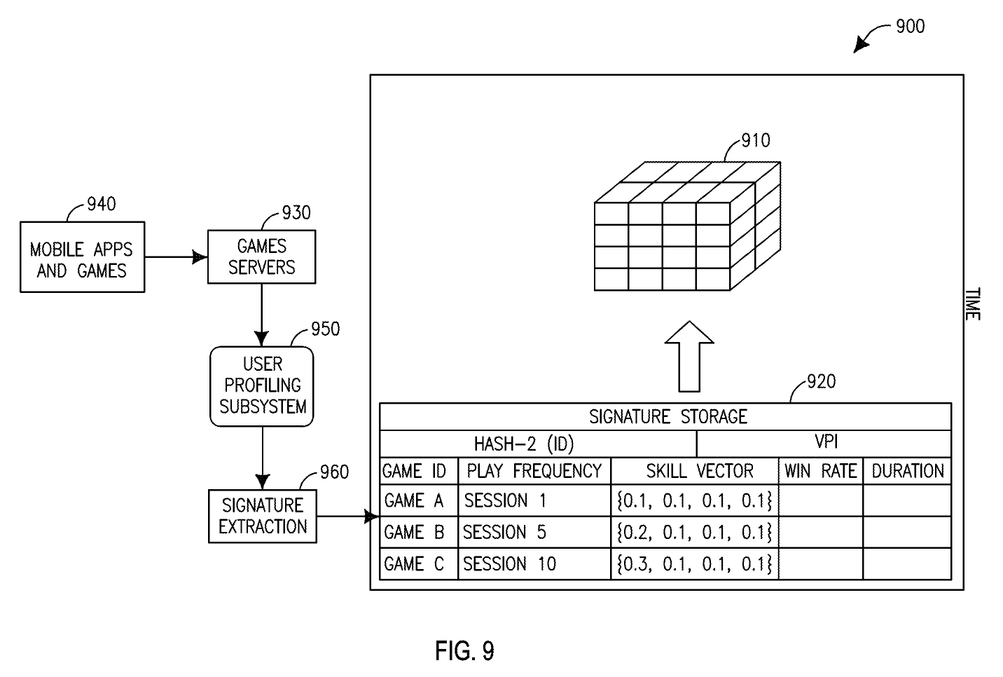

FIG. 9 is a block diagram of an example system 900 for storing user metrics and user behavior rhythms (e.g., as a signature 920) in a data cube 910. For example, the game metrics may include events generated from a game server 930 for mobile apps and/or games 940 and sent to a user profiling subsystem 950 which may derive statistical information, such as via signature extraction 960, about the user behavior. Such user gaming metrics may also be collected and parsed from an events log. This statistical information may include the user behavior data described in the previous sections. Each user may have only one data cube 910. Each data cube 910 may have 3 dimensions. The dimensions of data cube 910 may include device/platform, date and daily time period. Each element of data cube 910 may hold a vector of profile documents, each document storing a metrics table of a specific game with comprehensive aspects of gaming metrics in constraints of device, date and daily time period. If a user generates event logs, those events may be interpreted and distributed to the appropriate place in the user's data cube and to the correct profile document having a specific Game ID. Thereafter, each event may be parsed to update the metrics data.

To support utilization of players' “rhythm” as discussed in various embodiments herein, data cube 910 may record daily, monthly and yearly statistics for frequency of play, duration, win rate, and skill level assessment vectors for each player. For example, in a single player's skill-updating record, besides recording each event of skill vector calibration, system 900 may also calculate statistics, such as moving average and change, for different time frames (e.g., daily, weekly, monthly and yearly). In this way, system 900 may easily extract a historical “rhythm” of gaming and may build a time series predictive model for each individual player.

Rhythm variation is also described herein. In a first example scenario, a user may play only a single game. Player performance data such as win-loss rate, session length and playing frequency, may be collected as components of rhythm. For example, a player may play a game every day around 12 PM (frequency), each time playing for approximately 30 minutes (session length), with a win-loss rate of around 40%. If this player has abnormal “rhythm” in any of these components of the rhythm, it may be detected, and customer retention actions may be effected.

In another example scenario, a user may play multiple games, such as in a game bundle. In this scenario, players may play several games, and may switch games during a given play session. Player performance, such as win-loss rate, session length, and frequency may also be collected in this scenario. In addition, a game switching sequence may also be considered as a component of rhythm. For example, each time a player engages in a play session, that player may typically start with Game A, and after Game A is played for around 10 minutes with a good win-loss rate, that player may switch to play Game C for around 5 minutes, and then Game B and may finish the play session with Game D. In addition to frequency of playing activity, the sequences of Game A->Game C->Game B->Game D, along with playing performance and session length, may form the player “rhythm” in a multiple games scenario.

Further, a variation of signature is also provided. In addition to consideration of the players' performance, the level of opponents or AI may be determined according to the player's performance. For example, a player may exhibit good performance when playing with Player A, medium performance when playing with Player B, and low performance when playing with Player C. These pairs of opponents and performance may be a variation of signature for user identification.

Although features and elements may be described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but may be not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for providing a personalized service to a user based on anonymous user data, the method comprising:
receiving, by a receiver, historical user data from an online application session of a user which are not associated with a user identity of the user;
calculating, by a processor, predicted user data based on the received historical user data;
storing, in a storage, a data vector which includes the historical user data and predicted user data;
analyzing, by the processor, the data vector to generate a correlation of a set of the historical user data with the user, and to identify a personalized service for the user based on the set without knowledge of the user identity; and
providing, by the processor, the personalized service to the user which activates the online application session to provide the personalized service to the user on a condition that the user accesses the personalized service;
wherein analyzing the data vector comprises calculating a derivative vector as the derivative of the data vector, calculating a statistical vector based on the derivative vector, and extracting dominant coefficients from the statistical vector.

2. The method of claim 1, wherein the correlation comprises a signature.

3. The method of claim 2, further comprising generating an identifier for the correlated set of the historical user data as a hash of the signature.

4. The method of claim 3, wherein the personalized service is accessible by the user based on the identifier.

5. The method of claim 1, further comprising encrypting at least a portion of the data vector based on the identifier.

6. (canceled)

7. The method of claim 1, wherein analyzing the data vector comprises comparing the predicted user data with the historical user data.

8. The method of claim 7, wherein the comparing comprises a similarity search.

9. The method of claim 1, wherein receiving the user data comprises capturing events.

10. The method of claim 2, further comprising storing the signature in a data cube.

11. A computer server configured to provide a personalized service to a user based on anonymous user data, the server comprising:
a receiver configured to receive historical user data from an online application session of a user which are not associated with a user identity;
a processor configured to calculate predicted user data based on the received historical user data;
a storage configured to store a data vector which includes the historical user data and predicted user data;
the processor further configured to analyze the data vector to generate a correlation of a set of the historical user data with the user, and to identify a personalized service for the user based on the set without knowledge of the user identity; and
the processor further configured to provide the personalized service to the user based on the correlation, which activates the online application to provide the personalized service to the user on a condition that the user accesses the personalized service;
wherein analyzing the data vector comprises calculating a derivative vector as the derivative of the data vector, calculating a statistical vector based on the derivative vector, and extracting dominant coefficients from the statistical vector.

12. The computer server of claim 10, wherein the correlation comprises a signature.

13. The computer server of claim 12, wherein the processor is further configured to generate an identifier for the correlated set of the historical user data as a hash of the signature.

14. The computer server of claim 13, wherein the computer server is configured to permit the user to access the personalized service based on the identifier.

15. The computer server of claim 11, wherein the processor is further configured to encrypt at least a portion of the data vector based on the identifier.

16. (canceled)

17. The computer server of claim 11, wherein analyzing the data vector comprises comparing the predicted user data with the historical user data.

18. The computer server of claim 17, wherein the comparing comprises a similarity search.

19. The computer server of claim 11, wherein receiving the user data comprises capturing events.

20. The computer server of claim 12, wherein the storage is further configured to store the signature in a data cube.
